(19) United States
(12) Patent Application Publication
(10) Pub. No.: US 2023/0137574 A1
(43) Pub. Date: May 4, 2023

(54) SYSTEM, METHOD, AND COMPUTER PROGRAM PRODUCT FOR PROCESSING AN ELECTRONIC PAYMENT TRANSACTION HAVING A CUSTOM INTERCHANGE RATE

(71) Applicant: Visa International Service Association, San Francisco, CA (US)

(72) Inventors: Brian Edward Marx, Roseland, NJ (US); Abhishek, Scarsdale, NY (US); Deepak Kumar Tomar, Fremont, CA (US); Kate J. Kennedy, Marina, CA (US); Patricia Torres, Oshawa (CA); Brenda Lee Geene, Castle Rock, CO (US)

(21) Appl. No.: 17/519,116

(22) Filed: Nov. 4, 2021

(51) Int. Cl. G06Q 20/08; G06Q 20/32

(52) U.S. Cl. CPC G06Q 20/085; G06Q 20/322

(57) ABSTRACT

A method for processing an electronic payment transaction includes: storing a data entry including an agreement identifier, a merchant identifier, an issuer identifier, and an interchange rate in a database; receiving a transaction request message associated with an electronic payment transaction between a merchant and a user, the transaction request message including a plurality of data fields including a transaction amount, the merchant identifier, and the issuer identifier; querying the database to retrieve the agreement identifier; and generating an authorization request message and/or a transaction response message including a data field including the agreement identifier and causing settlement of the electronic payment transaction based on the at least one first interchange rate associated with the first agreement identifier.

### BACKGROUND

### 1. Field

This disclosure relates generally to processing electronic payment transactions and, in some non-limiting embodiments or aspects, to systems, methods, and computer program products for processing electronic payment transactions having a custom interchange rate.

### 2. Technical Considerations

An interchange rate is a fee that a merchant is required to pay for each electronic payment transaction initiated between that merchant and a consumer and processed over a payment network. This fee is paid to an issuer of the consumer's payment device in return for those financial institutions accepting the credit risk associated with the electronic payment transaction and for handling processing thereof. The interchange rate is typically some percentage of the transaction amount. Existing payment networks are rigidly configured to apply a single interchange rate to every transaction processed thereby, regardless of transaction amount, merchants and issuers involved, and the like. Practically, this rigidity in the payment network discourages certain types of transactions from being conducted as electronic payment transactions, particularly those transactions involving commercial consumers using a commercial payment device.

### SUMMARY

According to some non-limiting embodiments or aspects, a method for processing an electronic payment transaction includes: storing, with at least one processor, a plurality of data entries in at least one database, each data entry associated with a different merchant-issuer agreement and including an agreement identifier, a merchant identifier, an issuer identifier, and at least one interchange rate, where a first data entry of the plurality of data entries includes a first agreement identifier, a first merchant identifier, a first issuer identifier, and at least one first interchange rate; receiving, with at least one processor, a transaction request message associated with an electronic payment transaction between a first merchant and a first user, the transaction request message including a plurality of data fields including a transaction amount, the first merchant identifier associated with the first merchant, and the first issuer identifier associated with a first issuer of a payment device of the first user; in response to receiving the transaction request message, querying, with at least one processor, the at least one database to retrieve the first agreement identifier based on the first merchant identifier matching the merchant identifier and the first issuer identifier matching the issuer identifier associated with the first agreement identifier and; generating, with at least one processor, at least one of an authorization request message including a data field including the first agreement identifier and a transaction response message including a data field including the first agreement identifier and causing settlement of the electronic payment transaction based on the at least one first interchange rate associated with the first agreement identifier.

In non-limiting embodiments or aspects, retrieving the first agreement identifier and generating the authorization request message and/or the transaction response message including the data field including the first agreement identifier may be completed in real-time relative to receiving the transaction request message. The transaction request message may further include a data field including a first acquirer identifier associated with a first acquirer associated with the first merchant, and the method may further include: based on the first acquirer identifier of the transaction request message, determining, with at least one processor, that the first acquirer is an enrolled acquirer, where the at least one database is queried in response to determining that the first acquirer is an enrolled acquirer. The first user may be a commercial user, and the first payment device may be a commercial payment device. The at least one first interchange rate may include a plurality of first interchange rates, where each of the plurality of first interchange rates corresponds to a transaction amount range, and the method may further include: matching, with at least one processor, the transaction amount to the relevant transaction amount range; and causing, with at least one processor, settlement of the electronic payment transaction that applies the first interchange rate of the plurality of first interchange rates corresponding to the relevant transaction amount range. The at least one first interchange rate may differ from a default interchange rate applied to electronic payment transactions. The retrieval of the first agreement identifier from the at least one database may cause the electronic payment transaction to be settled based on the at least one first interchange rate as opposed to the default interchange rate. A second data entry of the plurality of data entries may include a second agreement identifier, a second merchant identifier associated with a second merchant different from the first merchant, the first issuer identifier, and at least one second interchange rate.

According to some non-limiting embodiments or aspects, a system for processing an electronic payment transaction includes at least one processor programmed and/or configured to: store a plurality of data entries in at least one database, each data entry associated with a different merchant-issuer agreement and including an agreement identifier, a merchant identifier, an issuer identifier, and at least one interchange rate, where a first data entry of the plurality of data entries includes a first agreement identifier, a first merchant identifier, a first issuer identifier, and at least one first interchange rate; receive a transaction request message associated with an electronic payment transaction between a first merchant and a first user, the transaction request message including a plurality of data fields including a transaction amount, the first merchant identifier associated with the first merchant, and the first issuer identifier associated with a first issuer of a payment device of the first user; in response to receiving the transaction request message, query the at least one database to retrieve the first agreement identifier based on the first merchant identifier matching the merchant identifier and the first issuer identifier matching the issuer identifier associated with the first agreement identifier and; generate at least one of an authorization request message including a data field including the first agreement identifier and a transaction response message including a data field including the first agreement identifier and cause settlement of the electronic payment transaction based on the at least one first interchange rate associated with the first agreement identifier.

In non-limiting embodiments or aspects, retrieving the first agreement identifier and generating the authorization request message and/or the transaction response message including the data field including the first agreement identifier may be completed in real-time relative to receiving the transaction request message. The transaction request message may further include a data field including a first acquirer identifier associated with a first acquirer associated with the first merchant, and the at least one processor may be further programmed and/or configured to: based on the first acquirer identifier of the transaction request message, determine that the first acquirer is an enrolled acquirer, where the at least one database is queried in response to determining that the first acquirer is an enrolled acquirer. The first user may be a commercial user, and the first payment device may be a commercial payment device. The at least one first interchange rate may include a plurality of first interchange rates, where each of the plurality of first interchange rates corresponds to a transaction amount range, and the at least one processor may be further programmed and/or configured to: match the transaction amount to the relevant transaction amount range; and cause settlement of the electronic payment transaction that applies the first interchange rate of the plurality of first interchange rates corresponding to the relevant transaction amount range. The at least one first interchange rate may differ from a default interchange rate applied to electronic payment transactions. The retrieval of the first agreement identifier from the at least one database may cause the electronic payment transaction to be settled based on the at least one first interchange rate as opposed to the default interchange rate. A second data entry of the plurality of data entries may include a second agreement identifier, a second merchant identifier associated with a second merchant different from the first merchant, the first issuer identifier, and at least one second interchange rate.

According to some non-limiting embodiments or aspects, a computer program product for processing an electronic payment transaction includes at least one non-transitory computer-readable medium including program instructions that, when executed by at least one processor, cause the at least one processor to: store a plurality of data entries in at least one database, each data entry associated with a different merchant-issuer agreement and including an agreement identifier, a merchant identifier, an issuer identifier, and at least one interchange rate, where a first data entry of the plurality of data entries includes a first agreement identifier, a first merchant identifier, a first issuer identifier, and at least one first interchange rate; receive a transaction request message associated with an electronic payment transaction between a first merchant and a first user, the transaction request message including a plurality of data fields including a transaction amount, the first merchant identifier associated with the first merchant, and the first issuer identifier associated with a first issuer of a payment device of the first user; in response to receiving the transaction request message, query the at least one database to retrieve the first agreement identifier based on the first merchant identifier matching the merchant identifier and the first issuer identifier matching the issuer identifier associated with the first agreement identifier and; generate at least one of an authorization request message including a data field including the first agreement identifier and a transaction response message including a data field including the first agreement identifier and cause settlement of the electronic payment transaction based on the at least one first interchange rate associated with the first agreement identifier.

In non-limiting embodiments or aspects, retrieving the first agreement identifier and generating the authorization request message and/or the transaction response message including the data field including the first agreement identifier may be completed in real-time relative to receiving the transaction request message. The transaction request message may further include a data field including a first acquirer identifier associated with a first acquirer associated with the first merchant, and the program instructions, when executed by at least one processor, may cause the at least one processor to: based on the first acquirer identifier of the transaction request message, determine that the first acquirer is an enrolled acquirer, where the at least one database is queried in response to determining that the first acquirer is an enrolled acquirer. The first user may be a commercial user, and the first payment device may be a commercial payment device. The at least one first interchange rate may include a plurality of first interchange rates, where each of the plurality of first interchange rates corresponds to a transaction amount range, and the program instructions, when executed by at least one processor, may cause the at least one processor to: match the transaction amount to the relevant transaction amount range; and cause settlement of the electronic payment transaction that applies the first interchange rate of the plurality of first interchange rates corresponding to the relevant transaction amount range. The at least one first interchange rate may differ from a default interchange rate applied to electronic payment transactions. The retrieval of the first agreement identifier from the at least one database may cause the electronic payment transaction to be settled based on the at least one first interchange rate as opposed to the default interchange rate. A second data entry of the plurality of data entries may include a second agreement identifier, a second merchant identifier associated with a second merchant different from the first merchant, the first issuer identifier, and at least one second interchange rate.

Further non-limiting embodiments or aspects are set forth in the following numbered clauses:

Clause 1: A method for processing an electronic payment transaction, comprising: storing, with at least one processor, a plurality of data entries in at least one database, each data entry associated with a different merchant-issuer agreement and comprising an agreement identifier, a merchant identifier, an issuer identifier, and at least one interchange rate, wherein a first data entry of the plurality of data entries comprises a first agreement identifier, a first merchant identifier, a first issuer identifier, and at least one first interchange rate; receiving, with at least one processor, a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user; in response to receiving the transaction request message, querying, with at least one processor, the at least one database to retrieve the first agreement identifier based on the first merchant identifier matching the merchant identifier and the first issuer identifier matching the issuer identifier associated with the first agreement identifier; and generating, with at least one processor, at least one of an authorization request message comprising a data field including the first agreement identifier and a transaction response message comprising a data field including the first agreement identifier and causing settlement of the electronic payment transaction based on the at least one first interchange rate associated with the first agreement identifier.

Clause 2: The method of clause 1, wherein retrieving the first agreement identifier and generating the authorization request message and/or the transaction response message comprising the data field including the first agreement identifier are completed in real-time relative to receiving the transaction request message.

Clause 3: The method of clause 1 or 2, wherein the transaction request message further comprises a data field including a first acquirer identifier associated with a first acquirer associated with the first merchant, the method further comprising: based on the first acquirer identifier of the transaction request message, determining, with at least one processor, that the first acquirer is an enrolled acquirer, wherein the at least one database is queried in response to determining that the first acquirer is an enrolled acquirer.

Clause 4: The method of any of clauses 1-3, wherein the first user is a commercial user, wherein the first payment device is a commercial payment device.

Clause 5: The method of any of clauses 1-4, wherein the at least one first interchange rate comprises a plurality of first interchange rates, wherein each of the plurality of first interchange rates corresponds to a transaction amount range, the method further comprising: matching, with at least one processor, the transaction amount to the relevant transaction amount range; and causing, with at least one processor, settlement of the electronic payment transaction that applies the first interchange rate of the plurality of first interchange rates corresponding to the relevant transaction amount range.

Clause 6: The method of any of clauses 1-5, wherein the at least one first interchange rate differs from a default interchange rate applied to electronic payment transactions.

Clause 7: The method of any of clauses 1-6, wherein retrieving the first agreement identifier from the at least one database causes the electronic payment transaction to be settled based on the at least one first interchange rate as opposed to the default interchange rate.

Clause 8: The method of any of clauses 1-7, wherein a second data entry of the plurality of data entries comprises a second agreement identifier, a second merchant identifier associated with a second merchant different from the first merchant, the first issuer identifier, and at least one second interchange rate.

Clause 9: The method of any of clauses 1-8, further comprising transmitting, with at least one processor, the authorization request message to a first issuer system associated with the first issuer and/or transmitting, with at least one processor, the transaction response message to a first acquirer system associated with the first merchant, wherein the authorization request message and/or the transaction response message is configured to cause the first issuer system and/or the first acquirer system to settle the electronic payment transaction based on the at least one first interchange rate associated with the first agreement identifier.

Clause 10: A system for processing an electronic payment transaction, comprising at least one processor programmed and/or configured to: store a plurality of data entries in at least one database, each data entry associated with a different merchant-issuer agreement and comprising an agreement identifier, a merchant identifier, an issuer identifier, and at least one interchange rate, wherein a first data entry of the plurality of data entries comprises a first agreement identifier, a first merchant identifier, a first issuer identifier, and at least one first interchange rate; receive a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user; in response to receiving the transaction request message, query the at least one database to retrieve the first agreement identifier based on the first merchant identifier matching the merchant identifier and the first issuer identifier matching the issuer identifier associated with the first agreement identifier and; generate at least one of an authorization request message comprising a data field including the first agreement identifier and a transaction response message comprising a data field including the first agreement identifier and cause settlement of the electronic payment transaction based on the at least one first interchange rate associated with the first agreement identifier.

Clause 11: The system of clause 10, wherein retrieving the first agreement identifier and generating the authorization request message and/or the transaction response message comprising the data field including the first agreement identifier are completed in real-time relative to receiving the transaction request message.

Clause 12: The system of clause 10 or 11, wherein the transaction request message further comprises a data field including a first acquirer identifier associated with a first acquirer associated with the first merchant, wherein the at least one processor is further programmed and/or configured to: based on the first acquirer identifier of the transaction request message, determine that the first acquirer is an enrolled acquirer, wherein the at least one database is queried in response to determining that the first acquirer is an enrolled acquirer.

Clause 13: The system of any of clauses 10-12, wherein the first user is a commercial user, wherein the first payment device is a commercial payment device.

Clause 14: The system of any of clauses 10-13, wherein the at least one first interchange rate comprises a plurality of first interchange rates, wherein each of the plurality of first interchange rates corresponds to a transaction amount range, wherein the at least one processor is further programmed and/or configured to: match the transaction amount to the relevant transaction amount range; and cause settlement of the electronic payment transaction that applies the first interchange rate of the plurality of first interchange rates corresponding to the relevant transaction amount range.

Clause 15: The system of any of clauses 10-14, wherein the at least one first interchange rate differs from a default interchange rate applied to electronic payment transactions.

Clause 16: The system of any of clauses 10-15, wherein retrieving the first agreement identifier from the at least one database causes the electronic payment transaction to be settled based on the at least one first interchange rate as opposed to the default interchange rate.

Clause 17: The system of any of clauses 10-16, wherein a second data entry of the plurality of data entries comprises a second agreement identifier, a second merchant identifier associated with a second merchant different from the first merchant, the first issuer identifier, and at least one second interchange rate.

Clause 18: The system of any of clauses 10-17, wherein the at least one processor is programmed and/or configured to: transmit the authorization request message to a first issuer system associated with the first issuer and/or transmit the transaction response message to a first acquirer system associated with the first merchant, wherein the authorization request message and/or the transaction response message is configured to cause the first issuer system and/or the first acquirer system to settle the electronic payment transaction based on the at least one first interchange rate associated with the first agreement identifier.

Clause 19: A computer program product for processing an electronic payment transaction, comprising at least one non-transitory computer-readable medium including program instructions that, when executed by at least one processor, cause the at least one processor to: store a plurality of data entries in at least one database, each data entry associated with a different merchant-issuer agreement and comprising an agreement identifier, a merchant identifier, an issuer identifier, and at least one interchange rate, wherein a first data entry of the plurality of data entries comprises a first agreement identifier, a first merchant identifier, a first issuer identifier, and at least one first interchange rate; receive a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user; in response to receiving the transaction request message, query the at least one database to retrieve the first agreement identifier based on the first merchant identifier matching the merchant identifier and the first issuer identifier matching the issuer identifier associated with the first agreement identifier and; generate at least one of an authorization request message comprising a data field including the first agreement identifier and a transaction response message comprising a data field including the first agreement identifier and cause settlement of the electronic payment transaction based on the at least one first interchange rate associated with the first agreement identifier.

Clause 20: The computer program product of clause 19, wherein retrieving the first agreement identifier and generating the authorization request message and/or the transaction response message comprising the data field including the first agreement identifier are completed in real-time relative to receiving the transaction request message.

Clause 21: The computer program product of clause 19 or 20, wherein the transaction request message further comprises a data field including a first acquirer identifier associated with a first acquirer associated with the first merchant, wherein the program instructions, when executed by at least one processor, cause the at least one processor to: based on the first acquirer identifier of the transaction request message, determine that the first acquirer is an enrolled acquirer, wherein the at least one database is queried in response to determining that the first acquirer is an enrolled acquirer.

Clause 22: The computer program product of any of clauses 19-21, wherein the first user is a commercial user, wherein the first payment device is a commercial payment device.

Clause 23: The computer program product of any of clauses 19-22, wherein the at least one first interchange rate comprises a plurality of first interchange rates, wherein each of the plurality of first interchange rates corresponds to a transaction amount range, wherein the program instructions, when executed by at least one processor, cause the at least one processor to: match the transaction amount to the relevant transaction amount range; and cause settlement of the electronic payment transaction that applies the first interchange rate of the plurality of first interchange rates corresponding to the relevant transaction amount range.

Clause 24: The computer program product of any of clauses 19-23, wherein the at least one first interchange rate differs from a default interchange rate applied to electronic payment transactions.

Clause 25: The computer program product of any of clauses 19-24, wherein retrieving the first agreement identifier from the at least one database causes the electronic payment transaction to be settled based on the at least one first interchange rate as opposed to the default interchange rate.

Clause 26: The computer program product of any of clauses 19-25, wherein a second data entry of the plurality of data entries comprises a second agreement identifier, a second merchant identifier associated with a second merchant different from the first merchant, the first issuer identifier, and at least one second interchange rate.

Clause 27: The computer program product of any of clauses 19-26, wherein the program instructions, when executed by at least one processor, cause the at least one processor to transmit the authorization request message to a first issuer system associated with the first issuer and/or transmit the transaction response message to a first acquirer system associated with the first merchant, wherein the authorization request message and/or the transaction response message is configured to cause the first issuer system and/or the first acquirer system to settle the electronic payment transaction based on the at least one first interchange rate associated with the first agreement identifier.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 shows a system for processing electronic payment transactions, according to some non-limiting embodiments or aspects;

FIG. 2 shows a system for generating merchant-issuer interchange rate agreements, according to some non-limiting embodiments or aspects;

FIG. 3 shows a system for transmitting merchant-issuer interchange rate agreements to a transaction processing system, according to some non-limiting embodiments or aspects;

FIG. 4 shows a table of merchant-issuer interchange rate agreements, according to some non-limiting embodiments or aspects;

FIG. 5 shows a table of a tiered merchant-issuer interchange rate agreement, according to some non-limiting embodiments or aspects;

FIG. 6 shows a process flow diagram of a method and system for processing electronic payment transactions, according to some non-limiting embodiments or aspects; and

FIG. 7 shows a step diagram of a method for processing electronic payment transactions, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account data,” refers to any data concerning one or more accounts for one or more users. Account data may include, for example, one or more account identifiers, user identifiers, transaction histories, balances, credit limits, issuer institution identifiers, and/or the like.

As used herein, the term “account identifier” may refer to one or more types of identifiers associated with an account (e.g., a primary account number (PAN) associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as POS devices and/or POS systems used by a merchant. In some non-limiting embodiments, a client device may include an electronic device configured to communicate with one or more networks and/or facilitate payment transactions such as, but not limited to, one or more desktop computers, one or more portable computers (e.g., tablet computers), one or more mobile devices (e.g., cellular phones, smartphones, personal digital assistants (PDAs), wearable devices, such as watches, glasses, lenses, and/or clothing, and/or the like), and/or other like devices. Moreover, the term “client” may also refer to an entity, such as a merchant, that owns, utilizes, and/or operates a client device for facilitating payment transactions with a transaction service provider.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as one or more displays, processors, memory, input devices, network interfaces, and/or the like. The computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. The computing device may be a non-mobile device, such as a desktop computer. An “interface” refers to a generated display, such as one or more graphical user interfaces (GUIs) with which a user may interact, either directly or indirectly (e.g., through a keyboard, mouse, etc.).

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a PAN, to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, and/or the like. The payment device may include a volatile or a non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like operated by or on behalf of a payment gateway.

As used herein, the term “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, RFID receivers, and/or other contactless transceivers or receivers, contact-based receivers, payment terminals, and/or the like.

As used herein, the term “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

The term “processor,” as used herein, may represent any type of processing unit, such as a single processor having one or more cores, one or more cores of one or more processors, multiple processors each having one or more cores, and/or other arrangements and combinations of processing units. Reference to “at least one processor” can refer to a previously-recited processor or a different processor.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server,” “the server,” “at least one processor,” or “the at least one processor,” or the like, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices such as, but not limited to, processors, servers, client devices, software applications, and/or other like components.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, authorization is the process of approving or declining a transaction before a purchase is finalized or cash is disbursed. Clearing is the process of delivering final transaction data from acquirer system to issuer system for posting to the cardholder's account, the calculation of certain fees and charges that apply to the issuer and acquirer involved in the transaction, and the conversion of transaction amounts to the appropriate settlement currencies. Settlement is the process of calculating, determining, reporting, and transferring the net financial position of issuers and acquirers for all transactions that are cleared. A payment network can comprise multiple acquirers, multiple issuers, and multiple merchants.

Non-limiting embodiments or aspects improve existing systems for processing electronic payment transactions by enhancing its ability to apply custom interchange rates to settle the transactions. During the authorization of the electronic payment transaction, the acquirer system may submit a transaction request message to the transaction processing system, and the transaction request message may have a combination of data fields to enable the transaction to be settled using the custom interchange rate. The combination of data fields includes at least fields for transaction amount, merchant identifier, and issuer identifier. In response to receiving the transaction message, the transaction processing system may utilize the merchant identifier and issuer identifier fields to query a database to retrieve an agreement identifier corresponding to a merchant-issuer interchange rate agreement. The transaction processing system settles the electronic payment transaction according to the parameters of the retrieved merchant-issuer interchange rate agreement to apply a custom interchange rate different from a default interchange rate proscribed by the transaction processing system. Applying the custom interchange rate enables the payment network to more flexibly process transactions according to parameters requested by client merchants and issuers.

Further, non-limiting embodiments cause the system to process the electronic payment, retrieve the agreement identifier, and include the agreement identifier in at least one of an authorization request message to an issuer system or a transaction response message to an acquirer system in real-time relative to receiving the transaction request message, such that the system can efficiently and seamlessly apply the custom interchange rate during settlement. This may be executed using the existing messages transmitted to authorize, clear, and settle transactions, but may modify the existing messages with additional and/or modified data fields so as to enable the custom interchange rates to be applied during settlement without altering the message flows of the authorization, clearing, and settlement process. The additional and/or modified fields may cause the transaction processing system to retrieve the agreement identifier (also an additional or modified field) in real-time during authorization of the electronic payment transaction in response to receiving the transaction request message transmitted in existing systems to initiate authorization of electronic payment transactions. Therefore, the processing flexibility achieved by the system according to the present disclosure is effected with minimal disruption to existing processing flows.

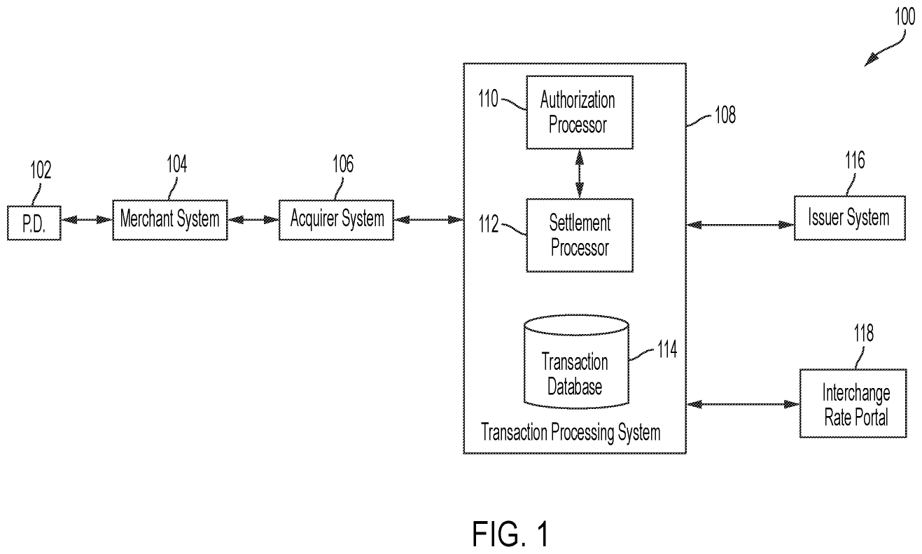

Referring to FIG. 1, a system 100 is shown for processing electronic payment transactions, according to some non-limiting embodiments or aspects. The electronic payment transactions may be initiated by a payment device 102 associated with a user, and the electronic payment transaction may include an exchange of products and/or services from a merchant for a transaction amount from the user. The payment device 102 may be a commercial payment device, and the user may be a commercial user. A commercial user refers to a non-individual entity engaging in commerce as a consumer, such as a business, organization, government entity, and the like, and a commercial payment device refers to at least one payment device issued by an issuer to the non-individual entity for initiating electronic payment transactions on behalf of the non-individual entity. The issuer may issue a payment account to the non-individual entity, and the payment account may be associated with the commercial payment device.

The processing of electronic payment transactions may include authorizing, clearing, and settling electronic payment transactions over an electronic payment network. The payment network may comprise a merchant system 104, an acquirer system 106, a transaction processing system 108, and an issuer system 116 communicating over the payment network to process electronic payment transactions. The payment network may comprise a plurality of merchant systems 104, acquirer systems 106, transaction processing systems 108, and issuer systems 116, with the relevant of each engaging in processing depending on the user and/or the merchant engaging in the electronic payment transaction. The merchant system 104 may be associated with a merchant engaging with the user in the electronic payment transaction. The acquirer system 106 may be associated with an acquirer corresponding to the merchant engaging with the user in the electronic payment transaction. The transaction processing system 108 may be associated with the transaction service provider corresponding to the payment device 102 used by the user to initiate the electronic payment transaction. The issuer system 116 may be associated with the issuer that issued the payment device 102 and/or payment account associated therewith to the user to initiate the electronic payment transaction.

With continued reference to FIG. 1, in some non-limiting embodiments or aspects, processing of an electronic payment transaction may be initiated using the payment device 102 of the user and the merchant system 104 of the merchant. The merchant system 104 may receive account data from the payment device 102, and may use the account data to initiate processing of the electronic payment transaction. For example, the account data may include data elements specified in ISO 8583. The account data may, for example, comprise a primary account number (PAN). The account data may comprise an issuer identifier identifying an issuer of the payment device 102. For example, the PAN or other account data may identify the issuer bank identification number (BIN) as an issuer identifier. The account data may correspond to a commercial payment device issued to a user by the issuer associated with the issuer identifier, and the commercial payment device may be eligible for processing using a custom interchange rate.

With continued reference to FIG. 1, in some non-limiting embodiments or aspects, in response to receiving the account data, the merchant system 104 may generate a transaction message containing data fields including at least a portion of the account data. The merchant system 104 may include additional transaction data in the transaction message used for processing the electronic payment transaction. The additional transaction data may include data elements specified in ISO 8583. The additional transaction data may comprise at least one of a transaction amount, data associated with the goods and/or services involved in the transaction, and/or a merchant identifier, which includes, as examples, an identifier of the merchant, a card acceptor identifier identifying a store location of the merchant, a POS device identifier identifying the POS device initiating the transaction, a Dun & Bradstreet Number, and/or the like. The merchant system 104 may transmit the transaction message to the acquirer system 106 associated with the merchant.

With continued reference to FIG. 1, in some non-limiting embodiments or aspects, in response to receiving the transaction message, the acquirer system 106 may generate a transaction request message containing data fields including at least a portion of the data from the transaction message. The acquirer system 106 may include further additional transaction data in the transaction message used for processing the electronic payment transaction. The further additional transaction data may include data elements specified in ISO 8583. The further additional transaction data may comprise at least one of the merchant identifier, an acquirer identifier, and/or the like.

The transaction request message generated by the acquirer system 106 may include a plurality of data fields comprising a transaction amount, the merchant identifier associated with the merchant, the issuer identifier associated with the issuer of the payment device 102 of the user, and optionally the acquirer identifier. The transaction request message may be formatted and/or arranged according to a standard specified by the transaction processing system 106, issuer system 116, and/or according to ISO 8583.The acquirer system 106 may transmit the transaction request message to the transaction processing system 108.

With continued reference to FIG. 1, in some non-limiting embodiments or aspects, in response to receiving the transaction request message, the transaction processing system 108 may initiate authorization of the electronic payment transaction. The authorization processor 110 may handle authorization activities associated with electronic payment transactions, and the settlement processor 112 may handle settlement activities associated with electronic payment transactions. It will be appreciated that the authorization processor 110 and the settlement processor 112 may each be a single processor or plurality of processors, or the authorization processor 110 and the settlement processor 112 may be the same processor or plurality of processors.

The transaction processing system 108 may generate an authorization request message containing data fields including at least a portion of the data from the transaction request message. The transaction processing system 108 may include further additional transaction data in the authorization request message used for authorizing the electronic payment transaction. The further additional transaction data may include data elements specified in ISO 8583, and the authorization request message may be formatted and/or arranged according to a standard specified by the transaction processing system 106, issuer system 116, and/or according to ISO 8583. The transaction processing system 108 may transmit the authorization request message to the issuer system 116 associated with the payment device 102 of the user to cause the issuer system 116 to generate an authorization decision associated with the electronic payment transaction.

With continued reference to FIG. 1, in some non-limiting embodiments or aspects, in response to receiving the authorization request message, the issuer system 116 may generate an authorization decision for the electronic payment transaction. The authorization decision may be to approve, approve-in-part, or decline the electronic payment transaction. In response to the authorization decision being to decline the electronic payment transaction, processing of the electronic payment transaction by the payment network may be terminated. In response to the authorization decision being to approve the electronic payment transaction, the payment network may continue processing of the electronic payment transaction, such as by continuing to clear and/or settle the electronic payment transaction. The issuer system 116 may generate an authorization response message comprising a data field containing an authorization indicator which indicates the authorization decision of the issuer system 116. The issuer system 116 may transmit the authorization response message to the transaction processing system 108.

With continued reference to FIG. 1, in some non-limiting embodiments or aspects, in response to receiving the authorization response message, the transaction processing system 108 may generate a transaction response message. The transaction response message may comprise a data field containing the authorization indicator. The transaction processing system 108 may transmit the transaction response message to the acquirer system 106. The acquirer system 106 may generate and communicate a message to the merchant system 104 containing a data field containing the authorization indicator to notify the merchant system 104 of the authorization decision.

With continued reference to FIG. 1, in some non-limiting embodiments or aspects, in response to receiving the transaction response message and based on the indicator indicating that authorization decision associated with the electronic payment transaction was approved, the acquirer system 106 may generate a settlement request message to cause settlement of the electronic payment transaction. The settlement request message may comprise a data field including data associated with the electronic payment transaction. The settlement request message may be generated specifically to initiate settlement of the electronic payment transaction or the settlement request message may be generated to initiate settlement of a plurality of payment transactions in a batch process. The data field including data associated with the electronic payment transaction may include a transaction identifier, which may be a unique identifier associated with the electronic payment transaction during processing so as to identify the electronic payment transaction during downstream processing. Any entity of the payment network may generate the transaction identifier, such as the merchant system 104, the acquirer system 106, the transaction processing system 108, and/or the issuer system 116. In some non-limiting embodiments or aspects, the transaction processing system 108 may generate the transaction identifier in response to receiving the transaction request message, and at least one of the authorization request message and the transaction response message may comprise a data field containing the transaction identifier. The transaction identifier may comprise a plurality of transaction data which when included in combination may be unique or non-unique to the electronic payment transaction. For example, the plurality of transaction data constituting the transaction identifier may comprise the merchant identifier, the issuer identifier, and the transaction amount. The settlement request message may comprise the merchant identifier associated with the electronic payment transaction.

The settlement request message generated by the acquirer system 106 and containing the transaction identifier and/or the merchant identifier may be communicated to the transaction processing system 108, such as the settlement processor 112 thereof. In response to receiving the settlement request message, the transaction processing system 108 may initiate processing of the settlement of the electronic payment transaction. Processing the settlement may comprise determining an interchange rate to be applied to the electronic payment transaction. The “interchange rate” refers the fee that the merchant is required to pay to the issuer for processing the electronic payment transaction. The interchange rate may be a flat fee, a fee corresponding to some percentage of the transaction amount, or some combination thereof. Processing the settlement may comprise determining a portion of the transaction amount to be transferred from an account of the issuer to an account of the acquirer. The account of the issuer may be the account issued to the user by the issuer. The portion of the transaction amount to be transferred may be calculated by subtracting the interchange rate and other fees due by the merchant (based on the electronic payment transaction) from the transaction amount. Processing the settlement may comprise transferring funds associated with the electronic payment transaction from the account of the issuer to the account of the acquirer (and/or vice versa). Processing the settlement may comprise transferring funds received by the acquirer from the issuer to an account associated with the merchant of the electronic payment transaction. The settlement process may include steps transferring funds from the issuer account of the user to the merchant account, less any fees due by the merchant to entities of the payment network, such as the interchange fee due by the merchant to the user.

Referring to FIGS. 1-3, in some non-limiting embodiments or aspects, the electronic payment transaction may be processed as described above (in connection with FIG. 1), and the processing may be executed based on a custom interchange rate. A custom interchange rate refers to an interchange rate different from the default interchange rate specified by the transaction processing system 108 and applicable to all electronic payment transactions that do not otherwise have a custom interchange rate associated therewith, as described hereinafter. The electronic payment transaction may be processed by applying a custom interchange rate as described hereinafter.

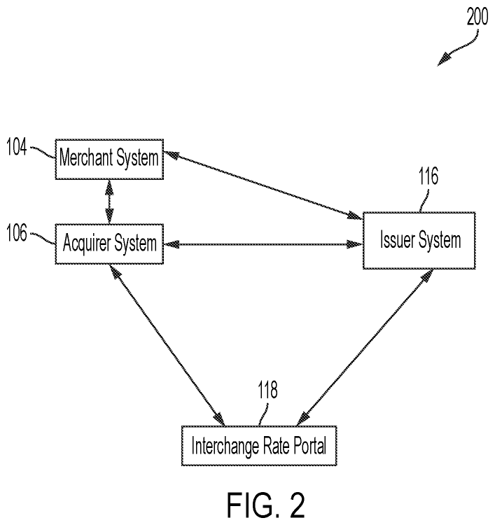

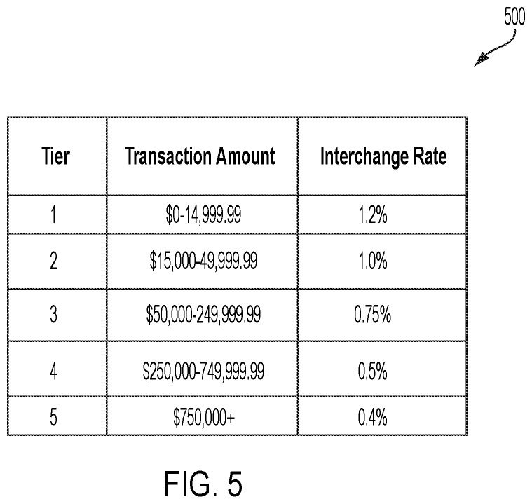

Referring to FIG. 2, a system 200 is shown for generating merchant-issuer interchange rate agreements, according to some non-limiting embodiments or aspects. The issuer system 116 may communicate with at least one merchant system 104, directly or indirectly though the acquirer system 106, or with the acquirer system 106 acting on behalf of the merchant system 104 to generate a merchant-issuer interchange rate agreement. The merchant-issuer interchange rate agreement may specify a custom interchange rate to be applied to all or a subset of electronic payment transactions involving the merchant and the issuer subject to the agreement. The subset of electronic payment transactions involving the merchant and the issuer may comprise transactions initiated using a commercial payment device. The subset of electronic payment transactions involving the merchant and the issuer may comprise a range of account numbers, which account numbers may be account data included in at least one of the transaction messages. The custom interchange rate may be a single rate for all relevant electronic payment transactions between the merchant and issuer or may comprise a schedule of interchange rates that varies based on at least one parameter of the transaction, such as transaction amount (see e.g., FIG. 5). The merchant-issuer interchange rate agreement may specify a start date and end date between which the custom interchange rate is applicable.

With continued reference to FIG. 2, in some non-limiting embodiments or aspects, the issuer system 116, merchant system 104, and/or the acquirer system 106 may generate an agreement registration message comprising a plurality of fields containing data associated with the parameters of the merchant-issuer interchange rate agreement. The agreement registration message may be transmitted to an interchange rate portal 118 configured to receive data associated with merchant-issuer interchange rate agreements from a plurality of merchant-issuer combinations. The interchange rate portal 118 may be operated by or on behalf of the transaction processing system 108 or by another 3^{rd} party transaction processing entity.

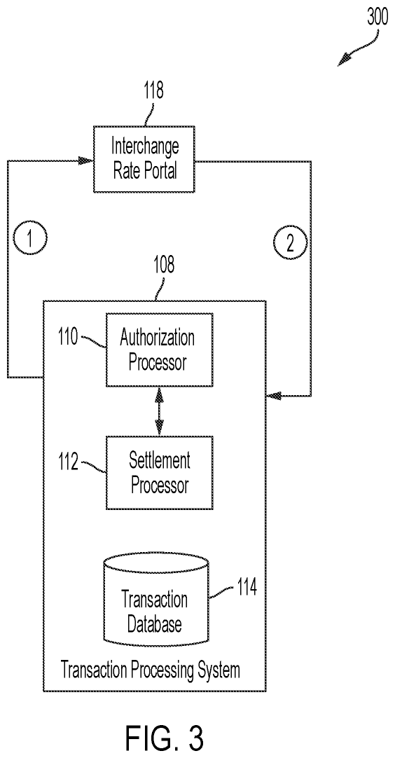

Referring to FIG. 3, a system 300 is shown for transmitting merchant-issuer interchange rate agreements to the transaction processing system 108, according to some non-limiting embodiments or aspects. At a step 1, the transaction processing system 108 may generate and communicate an inquiry message to the interchange rate portal 118 to request data associated with merchant-issuer interchange rate agreements received by the interchange rate portal 118. The inquiry message may be communicated periodically by the transaction processing system 108 to request updated or new merchant-issuer interchange rate agreements. At a step 2, the interchange rate portal 118 may generate and transmit an inquiry response message to the transaction processing system 108. The inquiry response message may comprise data fields containing data associated with the updated or new merchant-issuer interchange rate agreements, including the parameters of each. The system of FIG. 3 may be completed without step 1, in some non-limiting embodiments or aspects, with the interchange rate portal 118 generating and transmitting data associated with the updated or new merchant-issuer interchange rate agreements without first receiving an inquiry message.

With continued reference to FIG. 3, in some non-limiting embodiments or aspects, the transaction processing system 108 may store data associated with the received merchant-issuer interchange rate agreements in a transaction database 114. Since the transaction processing system 108 may receive data associated with a plurality of different merchant-issuer interchange rate agreements, the transaction processing system 108 may store a plurality of data entries in the transaction database 114, with each data entry associated with a different merchant-issuer agreement. Each data entry may comprise a merchant identifier associated with the merchant of the merchant-issuer agreement and an issuer identifier associated with the issuer of the merchant-issuer agreement. Each data entry may comprise data associated with at least one interchange rate. The data associated with at least one interchange rate may comprise an interchange rate to be used in each merchant-issuer electronic payment transaction or a schedule of interchange rates that varies based on at least one parameter of the electronic payment transaction, such as transaction amount (see e.g., FIG. 5). Each data entry may comprise an acquirer identifier associated with the acquirer of the merchant of the merchant-issuer agreement.

Each data entry may also comprise an agreement identifier to uniquely identify the merchant-issuer agreement among a plurality of merchant-issuer agreements stored in the transaction database 114. The agreement identifier may be generated by the interchange rate portal 118 or the transaction processing system 108 in response to receiving data associated with the merchant-issuer agreement. Each data entry may include additional details associated with the merchant-issuer agreements, such as the start date, the end data, and the like.

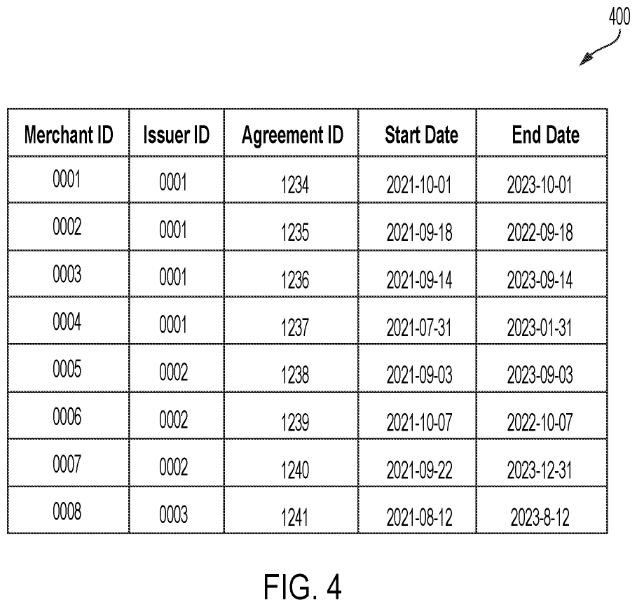

Referring to FIG. 4, a table 400 is shown of a plurality of data entries associated with merchant-issuer interchange rate agreements stored in the transaction database 114 (from FIG. 3), according to some non-limiting embodiments or aspects. The data entries may each comprise data specifying the merchant identifier and issuer identifier associated with the merchant-issuer agreement, the agreement identifier generated for and assigned to the merchant-issuer agreement, and the start and end date of the merchant-issuer agreement. The table 400 may include data entries associated with a plurality of different issuers (e.g., the issuers assigned issuer identifier 0001, 0002, and 0003). The table 400 may include a plurality of different data entries associated with a same issuer. For example, the table 400 includes four merchant-issuer agreements associated with the issuer assigned issuer identifier 0001, which were assigned agreement identifiers 1234-1237 and were made with the merchants having merchant identifiers 0001-0004. Thus, the same issuer may enter into a plurality of different merchant-issuer agreements such that the same issuer may have different agreements with different merchants with which it conducts electronic payment transactions.

Referring to FIG. 5, a table 500 is shown of a tiered schedule associated with a merchant-issuer agreement, according to some non-limiting embodiments or aspects. In this example, the schedule of interchange rates includes a plurality of tiers of interchange rates based on a parameter of the electronic payment transaction, such as the transaction amount. For each tier in the schedule, a range of transaction amounts may be associated with a custom interchange rate to be applied for the electronic payment transaction. For example, in Tier 1 from the table 500, for electronic payment transactions having a transaction amount of from $0-14,999.99, the interchange rate to be applied is 1.2% of the transaction amount, whereas for a higher ticket transaction amount, such as in Tiers 2-5, a lower interchange rate may be applied. However, any interchange rate may be tiered based on some other transaction parameter, and the relationship of interchange rate to relevant parameter may be customized in any suitable arrangement. At least one of the custom interchange rates in the schedule may be different than the default interchange rate specified by the transaction service provider of the transaction processing system 108 (from FIG. 3). It will be appreciated that the merchant-issuer agreement may include a tiered schedule of interchange rates, as shown in FIG. 5, or may specify a single custom interchange rate for all relevant electronic payment transactions between the merchant and issuer.

While the tiered schedule associated with a merchant-issuer agreements is shown in a separate table 500 in FIG. 5, the schedule of interchange rates or the single interchange rate associated with a merchant-issuer agreement may be stored in the same table 400 from FIG. 4. The tables in FIGS. 4 and 5 may be stored in the transaction database 114 (from FIG. 3).

Referring again to FIG. 1, a custom interchange rate may be applied to an electronic payment transaction, as opposed to the default interchange rate, according to some non-limiting embodiment or aspects. To process the electronic payment transaction using the custom interchange rate, the acquirer system 106 may generate the transaction request message that comprises a plurality of data fields containing the transaction amount, the merchant identifier, and the issuer identifier associated with the electronic payment transactions. The transaction request message may also comprise a data field containing the acquirer identifier associated with the acquirer system 106.

With continued reference to FIG. 1, in some non-limiting embodiments or aspects, in response to receiving the transaction request message, the transaction processing system 108 may determine whether the electronic payment transaction may be eligible for a program that may apply a custom interchange rate, which may trigger processing of the electronic payment transaction according to a separate protocol different from the default protocol which applies the default interchange rate. The transaction processing system 108 may determine that the electronic payment transaction may be eligible for the program based on the acquirer identifier contained in the transaction request message. Based on the acquirer identifier, the transaction processing system 108 may determine that the acquirer system 106 is associated with an enrolled acquirer participating in the program, such that the merchant-issuer involved in the electronic payment transaction may be associated with a merchant-issuer agreement. In response to determining that the acquirer system 106 is associated with an enrolled acquirer, the transaction processing system 108 may automatically determine whether the electronic payment transaction is to be processed using a custom interchange rate, which may include querying the transaction database 114 as described hereinafter.

With continued reference to FIG. 1, in some non-limiting embodiments or aspects, in response to receiving the transaction request message, the transaction processing system 108 may query the transaction database 114 to determine whether a merchant-issuer agreement applies to the electronic payment transaction and retrieve the agreement identifier based on the merchant identifier and the issuer identifier both matching a merchant identifier and issuer identifier from a same data entry in the transaction database 114 associated with a merchant-issuer agreement stored therein. Retrieving the first agreement identifier from the at least one database may cause the electronic payment transaction to be settled based on the custom interchange rate specified in the merchant-issuer agreement corresponding to the first agreement identifier as opposed to the default interchange rate. In response to determining that a merchant-issuer agreement applies to the electronic payment transaction, a program indicator may be associated with the electronic payment transaction, and the program indicator may be included as a field in subsequent messages (e.g., authorization request message, transaction response message, settlement request message, and the like) to indicate that the electronic payment transaction is to be processed using a custom interchange rate.

The transaction processing system 108 may generate the authorization request message which may comprise a data field including the retrieved agreement identifier, and the generated authorization request message may be communicated to the issuer system 116 to cause the issuer system 116 to generate an authorization decision associated with the electronic payment transaction. Thus, the authorization request message may comprise a data field containing the agreement identifier to notify the issuer system 116 that the electronic payment transaction is to be settled according to the custom interchange rate specified by the merchant-issuer agreement associated with the agreement identifier.

Additionally or alternatively, the transaction response message may comprise a data field containing the agreement identifier to notify the acquirer system 106 that the electronic payment transaction is to be settled according to the custom interchange rate specified by the merchant-issuer agreement associated with the agreement identifier. The transaction processing system 108 may generate the transaction response message which may comprise a data field including the retrieved agreement identifier, and the generated transaction response message may be communicated to the acquirer system 106.

With continued reference to FIG. 1, in some non-limiting embodiments or aspects, the transaction processing system 108 retrieving the agreement identifier may be completed in real-time relative to receiving the transaction request message, such that the agreement identifier may be included in the authorization request message at the time of requesting an authorization decision from the issuer system 116 and in the transaction response message at the time of transmitting the transaction response message to the acquirer system 106 at the time of receiving the authorization decision (from the authorization response message). The agreement identifier being retrieved and included in the authorization request message and/or the transaction response message in real-time may enable the system to process the electronic payment transaction according to a custom interchange rate while substantially maintaining the existing messaging process for authorizing electronic payment transactions.

With continued reference to FIG. 1, in some non-limiting embodiments or aspects, transmitting the authorization request message to the issuer system 116 and the transaction response message to the acquirer system 106 may be configured to cause the issuer system 116 and/or the first acquirer system 106 to settle the electronic payment transaction based on the at least one first interchange rate associated with the first agreement identifier.

In response to receiving the transaction response message, the acquirer system 106 may generate the settlement request message. The settlement request message may comprise a data field containing the transaction identifier and/or the merchant identifier and/or the issuer identifier and/or the transaction amount associated with the electronic payment transaction. The settlement request message may optionally include a data field containing the agreement identifier associated with the electronic payment transaction. The acquirer system 106 may communicate the settlement request message to the transaction processing system 108 to initiate settlement of the electronic payment transaction.

With continued reference to FIG. 1, in some non-limiting embodiments or aspects, in response to receiving the settlement request message, the transaction processing system 108 may identify the electronic payment transaction to be settled based on the transaction identifier and/or the merchant identifier and/or the issuer identifier and/or the transaction amount included in the settlement request message. In some non-limiting embodiments or aspects, the transaction processing system 108 may identify the interchange rate to be applied to the electronic payment transaction based on the agreement identifier included in the settlement request message. However, the settlement request message may not contain the agreement identifier, and the transaction processing system 108 may identify the interchange rate to be applied to the electronic payment transaction based on the transaction identifier and/or the merchant identifier. This is because the transaction processing system 108 (e.g., the authorization processor 110) may have the transaction identifier and/or merchant identifier and/or the issuer identifier and/or the transaction amount from the authorization steps of processing the electronic payment transaction, during which time the authorization processor also retrieved the agreement identifier. Therefore, the authorization processor 110 may already have the agreement identifier associated with electronic payment transaction. The authorization processor 110 may pass the agreement identifier and/or transaction identifier and/or merchant identifier and/or the issuer identifier and/or the transaction amount to the settlement processor 112 such that the transaction processing system 108 may process settlement of the electronic payment transaction in response to receiving the settlement request message containing at least the transaction identifier and/or the merchant identifier and/or the issuer identifier and/or the transaction amount from the acquirer system 106.

In some non-limiting embodiments or aspects, the custom interchange rate to be applied may comprise a schedule of interchange rates that varies based on at least one parameter of the transaction, such as transaction amount (see e.g., FIG. 5). Based on the agreement identifier, the transaction processing system 108 may query the schedule of interchange rates by matching the transaction amount of the electronic payment transaction to the relevant transaction amount range from the schedule of interchange rates and determine the custom interchange rate to be applied based on the relevant transaction amount range.

With continued reference to FIG. 1, in some non-limiting embodiments or aspects, in response to determining the custom interchange rate, the transaction processing system 108 may cause the electronic payment transaction to be settled by applying the custom interchange rate to the transaction amount. The funds specified by settling the electronic payment transaction using the custom interchange rate may be transferred from the account of the issuer to the account of the acquirer, such that the relevant portion of the transaction amount is effectively transferred from the user to the merchant.

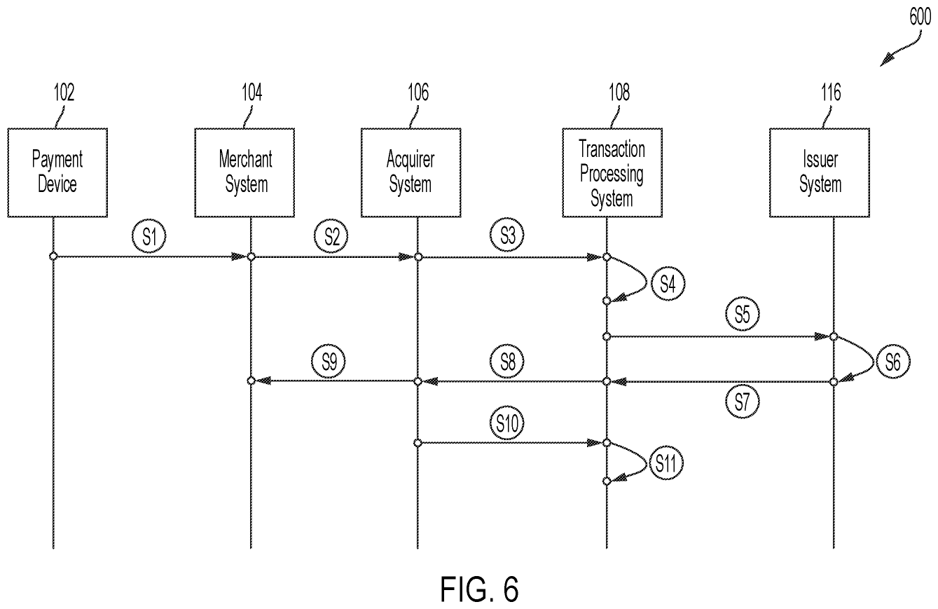

Referring to FIG. 6, a method and system 600 is shown for processing electronic payment transactions, according to some non-limiting embodiments or aspects. At a step S1, the user may initiate the electronic payment transaction with the merchant using the payment device 102. At a step S2, the merchant system 104 may receive account data used to process the electronic payment transaction from the payment device 102 and generate a transaction message comprising data fields containing at least a portion of the account data collected from the payment device 102. The merchant system 104 may communicate the transaction message to the acquirer system 106.

At a step S3, in response to receiving the transaction message, the acquirer system 106 may generate a transaction request message containing data fields including at least a portion of the data from the transaction message. The transaction request message may comprise data fields containing the transaction amount, the merchant identifier associated with the merchant, the issuer identifier associated with the issuer of the payment device 102 of the user, and optionally the acquirer identifier. The acquirer system 106 may communicate the transaction request message to the transaction processing system 108.

At a step S4, the transaction processing system 108 may query the transaction database 114 (from FIG. 1) to retrieve the agreement identifier based on the merchant identifier and the issuer identifier both matching a merchant identifier and issuer identifier from a same data entry in the transaction database 114 associated with a merchant-issuer agreement stored therein. At a step S5, the transaction processing system 108 may generate the authorization request message containing data fields including at least a portion of the data from the transaction request message, and the authorization request message may comprise a data field containing the agreement identifier. The transaction processing system 108 may communicate the authorization request message to the issuer system 116 associated with the issuer of the user's payment device 102.

With continued reference to FIG. 6, in some non-limiting embodiments or aspects, at a step S6, in response to receiving the authorization request message, the issuer system 116 may generate an authorization decision associated with the electronic payment transaction. In this example, the authorization decision may be to approve the electronic payment transaction. At a step S7, the issuer system 116 may generate the authorization response message comprising a data field containing the authorization indicator which indicates that the authorization decision was to approve the electronic payment transaction. The issuer system 116 may communicate the authorization response message to the transaction processing system 108.

With continued reference to FIG. 6, in some non-limiting embodiments or aspects, at a step S8, in response to receiving the authorization response message, the transaction processing system 108 may generate the transaction response message comprising a data field containing the authorization indicator and cause settlement of the electronic payment transaction based on the at least one first interchange rate associated with the first agreement identifier. The transaction response message may comprise a data field containing the agreement identifier. The transaction processing system 108 may communicate the transaction response message to the acquirer system 106.

With continued reference to FIG. 6, in some non-limiting embodiments or aspects, at a step S9, in response to receiving the transaction response message, the acquirer system 106 may generate a message comprising data fields containing at least a portion of the transaction response message, including the authorization indicator. The acquirer system 106 may communicate the message to the merchant system 104 to notify the merchant system 104 of the authorization decision for the electronic payment transaction.

With continued reference to FIG. 6, in some non-limiting embodiments or aspects, at a step S10, in response to the acquirer system 106 receiving the transaction response message containing the authorization indicator indicating that the electronic payment transaction has been approved, the acquirer system 106 may generate the settlement request message configured to cause settlement of the electronic payment transaction. The settlement request message may comprise data fields including the merchant identifier, issuer identifier, and transaction amount for identifying the electronic payment transaction to be settled. Optionally, the settlement request message may comprise a data field containing the agreement identifier. The acquirer system 106 may communicate the settlement request message to the transaction processing system 108 to cause the transaction processing system 108 to process settlement of the electronic payment transaction.

At a step S11, the transaction processing system 108 may process settlement of the electronic payment transaction in response to receiving the settlement request message. Processing the settlement may comprise determining the custom interchange rate to be applied to the electronic payment transaction based on the agreement identifier associated with the merchant-issuer combination. Based on the custom interchange rate, the transaction processing system 108 may initiate transfer of the funds between the various accounts involved in the electronic payment transaction, such as the issuer account associated with the user and the acquirer account associated with the merchant.

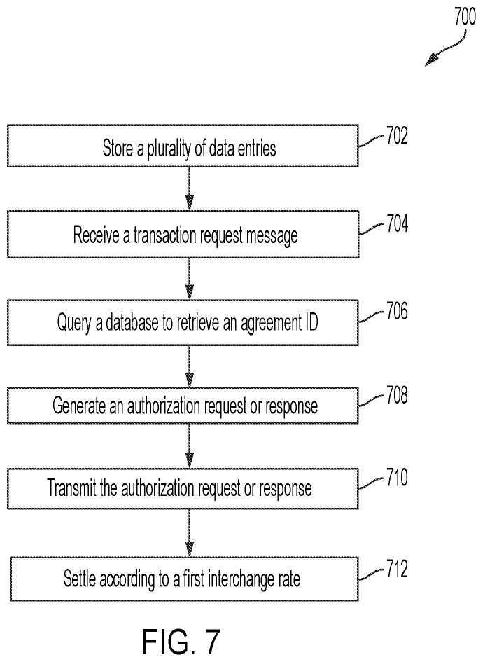

Referring to FIG. 7, a method 700 is shown for processing electronic payment transactions, according to some non-limiting embodiments or aspects. At a step 702, the transaction processing system may store a plurality of data entries in at least one database, each data entry associated with a different merchant-issuer agreement and comprising an agreement identifier, a merchant identifier, an issuer identifier, and at least one interchange rate. A first data entry of the plurality of data entries comprises a first agreement identifier, a first merchant identifier, a first issuer identifier, and at least one first interchange rate.

With continued reference to FIG. 7, in some non-limiting embodiments or aspects, at a step 704, the transaction processing system may receive a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user. At a step 706, in response to receiving the transaction request message, the transaction processing system may query the at least one database to retrieve the first agreement identifier based on the first merchant identifier matching the merchant identifier and the first issuer identifier matching the issuer identifier associated with the first agreement identifier. At a step 708, the transaction processing system may generate at least one of an authorization request message comprising a data field including the first agreement identifier and a transaction response message comprising a data field including the first agreement identifier and cause settlement of the electronic payment transaction based on the at least one first interchange rate associated with the first agreement identifier. At a step 710, the transaction processing system may transmit the authorization request message to a first issuer system associated with the first issuer and/or may transmit the transaction response message to a first acquirer system associated with the first merchant, wherein the authorization request message and/or the transaction response message is configured to cause the first issuer system and/or the first acquirer system to settle the electronic payment transaction based on the at least one first interchange rate associated with the first agreement identifier.

With continued reference to FIG. 7, in some non-limiting embodiments or aspects, at a step 712, the transaction processing system may settle the electronic payment transaction using the first interchange rate associated with the first agreement identifier.

In some non-limiting embodiment or aspects, a computer program product for processing electronic payment transactions includes at least one non-transitory computer readable medium including program instructions that, when executed by at least one processor, cause the at least one processor to execute one of the previously-described methods. The at least one processor may include any of the components shown in FIGS. 1-7 (e.g., the payment device 102, the merchant system 104, the acquirer system 106, the transaction processing system 108, the authorization processor 110, the settlement processor 112, the transaction database 114, the issuer system 116, the interchange rate portal 118, and the like).

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment, and one or more steps may be taken in a different order than presented in the present disclosure.

1. A method for processing an electronic payment transaction, comprising:
storing, with at least one processor, a plurality of data entries in at least one database, each data entry associated with a different merchant-issuer agreement and comprising an agreement identifier, a merchant identifier, an issuer identifier, and at least one interchange rate, wherein a first data entry of the plurality of data entries comprises a first agreement identifier, a first merchant identifier, a first issuer identifier, and at least one first interchange rate;
receiving, with at least one processor, a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user;
in response to receiving the transaction request message, querying, with at least one processor, the at least one database to retrieve the first agreement identifier based on the first merchant identifier matching the merchant identifier and the first issuer identifier matching the issuer identifier associated with the first agreement identifier;
generating, with at least one processor, at least one of an authorization request message comprising a data field including the first agreement identifier and a transaction response message comprising a data field including the first agreement identifier, wherein retrieving the first agreement identifier and generating the transaction response message comprising the data field including the first agreement identifier are completed in real-time relative to receiving the transaction request message; and
in response to retrieving the first agreement identifier, settling, with at least one processor, the electronic payment transaction based on the at least one first interchange rate associated with the first agreement identifier, wherein settling the electronic payment transaction comprises:
determining a custom interchange amount for the electronic payment transaction based on the transaction amount and the at least one first interchange rate: and
transferring a portion of the transaction amount from an account associated with the first issuer to an account associated with the first merchant, wherein the portion of the transaction amount transferred does not include the custom interchange amount.

2. (canceled)

3. The method of claim 1, wherein the transaction request message further comprises a data field including a first acquirer identifier associated with a first acquirer associated with the first merchant, the method further comprising:
based on the first acquirer identifier of the transaction request message, determining, with at least one processor, that the first acquirer is an enrolled acquirer,
wherein the at least one database is queried in response to determining that the first acquirer is an enrolled acquirer.

4. The method of claim 1, wherein the first user is a commercial user, wherein the first payment device is a commercial payment device.

5. The method of claim 1, wherein the at least one first interchange rate comprises a plurality of first interchange rates, wherein each of the plurality of first interchange rates corresponds to a transaction amount range, the method further comprising:
matching, with at least one processor, the transaction amount to the relevant transaction amount range; and
causing, with at least one processor, settlement of the electronic payment transaction that applies the first interchange rate of the plurality of first interchange rates corresponding to the relevant transaction amount range.

6. The method of claim 1, wherein the at least one first interchange rate differs from a default interchange rate applied to electronic payment transactions.

7. The method of claim 6, wherein retrieving the first agreement identifier from the at least one database causes the electronic payment transaction to be settled based on the at least one first interchange rate as opposed to the default interchange rate.

8. The method of claim 1, wherein a second data entry of the plurality of data entries comprises a second agreement identifier, a second merchant identifier associated with a second merchant different from the first merchant, the first issuer identifier, and at least one second interchange rate.

9. A system for processing an electronic payment transaction, comprising at least one processor programmed and/or configured to:
store a plurality of data entries in at least one database, each data entry associated with a different merchant-issuer agreement and comprising an agreement identifier, a merchant identifier, an issuer identifier, and at least one interchange rate, wherein a first data entry of the plurality of data entries comprises a first agreement identifier, a first merchant identifier, a first issuer identifier, and at least one first interchange rate;
receive a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user;
in response to receiving the transaction request message, query the at least one database to retrieve the first agreement identifier based on the first merchant identifier matching the merchant identifier and the first issuer identifier matching the issuer identifier associated with the first agreement identifier;
generate at least one of an authorization request message comprising a data field including the first agreement identifier and a transaction response message comprising a data field including the first agreement identifier, wherein retrieving the first agreement identifier and generating the transaction response message comprising the data field including the first agreement identifier are completed in real-time relative to receiving the transaction request message; and
in response to retrieving the first agreement identifier, settle the electronic payment transaction based on the at least one first interchange rate associated with the first agreement identifier, wherein, when settling the electronic payment transaction, the at least one processor is further programmed and/or configured to:
determine a custom interchange amount for the electronic payment transaction based on the transaction amount and the at least one first interchange rate; and
transfer a portion of the transaction amount from an account associated with the first issuer to an account associated with the first merchant, wherein the portion of the transaction amount transferred does not include the custom interchange amount.

10. (canceled)

11. The system of claim 9, wherein the transaction request message further comprises a data field including a first acquirer identifier associated with a first acquirer associated with the first merchant, wherein the at least one processor is further programmed and/or configured to:
based on the first acquirer identifier of the transaction request message, determine that the first acquirer is an enrolled acquirer,
wherein the at least one database is queried in response to determining that the first acquirer is an enrolled acquirer.

12. The system of claim 9, wherein the first user is a commercial user, wherein the first payment device is a commercial payment device.

13. The system of claim 9, wherein the at least one first interchange rate comprises a plurality of first interchange rates, wherein each of the plurality of first interchange rates corresponds to a transaction amount range, wherein the at least one processor is further programmed and/or configured to:
match the transaction amount to the relevant transaction amount range; and
cause settlement of the electronic payment transaction that applies the first interchange rate of the plurality of first interchange rates corresponding to the relevant transaction amount range.

14. The system of claim 9, wherein the at least one first interchange rate differs from a default interchange rate applied to electronic payment transactions.

15. The system of claim 14, wherein retrieving the first agreement identifier from the at least one database causes the electronic payment transaction to be settled based on the at least one first interchange rate as opposed to the default interchange rate.

16. The system of claim 9, wherein a second data entry of the plurality of data entries comprises a second agreement identifier, a second merchant identifier associated with a second merchant different from the first merchant, the first issuer identifier, and at least one second interchange rate.

17. A computer program product for processing an electronic payment transaction, comprising at least one non-transitory computer-readable medium including program instructions that, when executed by at least one processor, cause the at least one processor to:
store a plurality of data entries in at least one database, each data entry associated with a different merchant-issuer agreement and comprising an agreement identifier, a merchant identifier, an issuer identifier, and at least one interchange rate, wherein a first data entry of the plurality of data entries comprises a first agreement identifier, a first merchant identifier, a first issuer identifier, and at least one first interchange rate;
receive a transaction request message associated with an electronic payment transaction between a first merchant and a first user, the transaction request message including a plurality of data fields comprising a transaction amount, the first merchant identifier associated with the first merchant, and the first issuer identifier associated with a first issuer of a payment device of the first user;
in response to receiving the transaction request message, query the at least one database to retrieve the first agreement identifier based on the first merchant identifier matching the merchant identifier and the first issuer identifier matching the issuer identifier associated with the first agreement identifier;
generate at least one of an authorization request message comprising a data field including the first agreement identifier and a transaction response message comprising a data field including the first agreement identifier, wherein retrieving the first agreement identifier and generating the transaction response message comprising the data field including the first agreement identifier are completed in real-time relative to receiving the transaction request message; and
in response to retrieving the first agreement identifier, settle the electronic payment transaction based on the at least one first interchange rate associated with the first agreement identifier, wherein the instructions that cause the at least one processor to settle further cause the at least one processor to:
determine a custom interchange amount for the electronic payment transaction based on the transaction amount and the at least one first interchange rate; and
transfer a portion of the transaction amount from an account associated with the first issuer to an account associated with the first merchant, wherein the portion of the transaction amount transferred does not include the custom interchange amount.

18. (canceled)

19. The computer program product of claim 17, wherein the transaction request message further comprises a data field including a first acquirer identifier associated with a first acquirer associated with the first merchant, wherein the program instructions, when executed by at least one processor, cause the at least one processor to:
based on the first acquirer identifier of the transaction request message, determine that the first acquirer is an enrolled acquirer,
wherein the at least one database is queried in response to determining that the first acquirer is an enrolled acquirer.

20. The computer program product of claim 17, wherein the at least one first interchange rate comprises a plurality of first interchange rates, wherein each of the plurality of first interchange rates corresponds to a transaction amount range, wherein the program instructions, when executed by at least one processor, cause the at least one processor to:
match the transaction amount to the relevant transaction amount range; and
cause settlement of the electronic payment transaction that applies the first interchange rate of the plurality of first interchange rates corresponding to the relevant transaction amount range.
